(19) United States
(12) Patent Application Publication
(10) Pub. No.: US 2012/0265844 A1
(43) Pub. Date: Oct. 18, 2012

(54) METHOD FOR ESTABLISHING A PERSONAL DATABASE

(75) Inventor: Yi-Hsiang Chen, New Taipei City (TW)

(73) Assignee: RICHPLAYTECHNOLOGY CORP., New Taipei City (TW)

(21) Appl. No.: 13/176,549

(22) Filed: Jul. 5, 2011

(30) Foreign Application Priority Data
Apr. 15, 2011 (TW) 100113110

(51) Int. Cl. G06F 15/16

(52) U.S. Cl. 709/217

(57) ABSTRACT

The present invention relates to a method for establishing a personal database, using which after a member of a website, that is functioning as a portal website, had provided one's personal information on paper to a website administrator of the website and the paper-based personal information is digitalized to be used for establishing an personal electronic file and personal database relating to the member, the member after logging into the website is authorized to obtain an online reading service or file downloading service from the website. Moreover, by the service provided by the website for rapidly digitalizing paper-based documentations, a corporate user of the website can easily build an electronic library as required that is managed by the administrators of the website.

### CROSS-REFERENCE TO RELATED APPLICATION

This non-provisional application claims priority under 35 U.S.C. §119(a) on Patent Application No. 100113110 filed in Taiwan (R.O.C.) on Apr. 15, 2011, the entire contents of which are hereby incorporated by reference.

### FIELD OF THE INVENTION

The present invention relates to a method for establishing a personal database, and more particularly, to a website capable of building an personal electronic file and personal database relating to a registered member by digitalizing the paper-based personal information of the member so as to be used for authorizing the member after logging into the website to obtain an online reading service or file downloading service from the website.

### BACKGROUND OF THE INVENTION

Nowadays, with the increasing advance and innovation of technology, there are various wired or wireless communication and networking systems that are available for transmitting all kinds of information to whoever needed without any regard to time, distance or other circumstances.

In recent years, using computer for work and logging onto Internet have been increasingly common. Consequently, there are all sorts of commercial websites that had been established on Internet, which are not only functioned for providing various services to their register members, but also are capable of facilitating the distribution and sharing of data through Internet. As the result, one of the focal point of technology development is to integrate all the electronic devices that are currently available and used in our daily life into devices with Internet access ability

The Internet is becoming a global system of interconnected computer networks that capable of serving billions of users worldwide. It is a network of networks that consists of millions of private, public, academic, business, and government networks. Most traditional communications media including telephone, music, film, and television are reshaped or redefined by the Internet, giving birth to new services such as Voice over Internet Protocol (VoIP) and IPTV. In addition, online shopping has boomed both for major retail outlets and small traders. Business-to-business and financial services on the Internet affect supply chains across entire industries. Not to mention that newspaper, book and other print publishing are adapting to Web site technology, or are reshaped into blogging and web feeds, and consequently, the conventional books and magazines that are generally too heavy to carry are gradually being replaced by electronic files, such as e-books that are registered on certain commercial websites. However, it might not be an easy task to search on Internet for locating the exact book that a user is intended to read, or simply a user can not find the one book on Internet that he/she is looking for, and therefore, the user will have to read the book that is printed on paper instead. Thus, it is in need of a means to overcome the aforesaid shortcoming for enabling any user to have the convenience of reading whichever e-book that the user is intended to read at any time.

### SUMMARY OF THE INVENTION

In view of the disadvantages of prior art, the primary object of the present invention is to provide a method for establishing a personal database, using which a website is provided and used for building an personal electronic file and personal database relating to a registered member by digitalizing the paper-based personal information of the member, and thus to be used for authorizing the member after logging into the website to obtain an online reading service or file downloading service from the website.

Another object of the present invention is to provide a method for establishing a personal database that is designed to equip a website with the ability to act in response to the request of its registered member for performing a return process or a donation process upon the paper-based personal information of the member.

Moreover, by the service provided by the website for rapidly digitalizing paper-based documentations, a corporate user of the website can easily build an electronic library as required that is managed by the administrators of the website.

To achieve the above objects, the present invention provides a method for establishing a personal database, comprising the steps of:
enabling a member to establishing an account on a website;
enabling the member to sending a paper-based personal information to an administrator of the website so as to be imaged using a high-speed camera or scanned into an electronic file;
uploading the electronic file to a web space in the website that is specified for the member while authorizing the member to obtain a free file download service; and
providing a specific reading software to the member.

Preferably, the method for establishing a personal database is designed to equip the website with the ability to act in response to the request of the member for performing a return process or a donation process upon the paper-based personal information of the member.

Preferably, the method for establishing a personal database further the step of:
authorizing the member to either read electronic files of the website in an online manner or to download electronic files from the website to a reading device.

Preferably, the reading device is a device selected from the group consisting of: a personal computer, a notebook computer, a tablet computer, a personal digital assistant and a cellular phone.

Preferably, the authorization of the member to either read electronic files of the website in an online manner or to download electronic files from the website to a reading device requires the member to input accurately an account number and a code corresponding to the account number that are legitimate to the website.

Preferably, the method for establishing a personal database further the step of:
establishing an electronic library while enabling the electronic library to be managed by the administrators of the website.

In addition, to achieve the above objects, the present invention provides further another method for establishing a personal database, comprising the steps of:
enabling the member to provide a paper-based personal information;
disposing the paper-based personal information on a cradle;
utilizing a robotic arm to perform a page turning operation upon the paper-based personal information while enabling the left and right of the paper-based personal information to be secured respectively by pressing panels arranged at two sides of the cradle;
using a light source along with a left and a right reflection mirrors for raising the brightness of the paper-based personal information;
using a high-speed camera for imaging or scanning the paper-based personal information so as to produce a electronic file of generic graphic format;
compressing the electronic file of generic graphic format into a compressed file of a specific format; and
providing a specific reading software to the member.

Preferably, the robotic arm is designed to perform the page turning operation by utilizing a vacuum means to exert a gentle suction upon pages of the paper-based personal information.

Preferably, the cradle is formed as a V-shaped object.

Preferably, the right reflection mirror is arranged to reflect light from the left of the paper-based personal information, while the left reflection mirror is arranged to reflect light from the right of the paper-based personal information.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a flow chart depicting a method for establishing a personal database according to an embodiment of the present invention.

FIG. 2 is another flow chart depicting a method for establishing a personal database according to another embodiment of the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

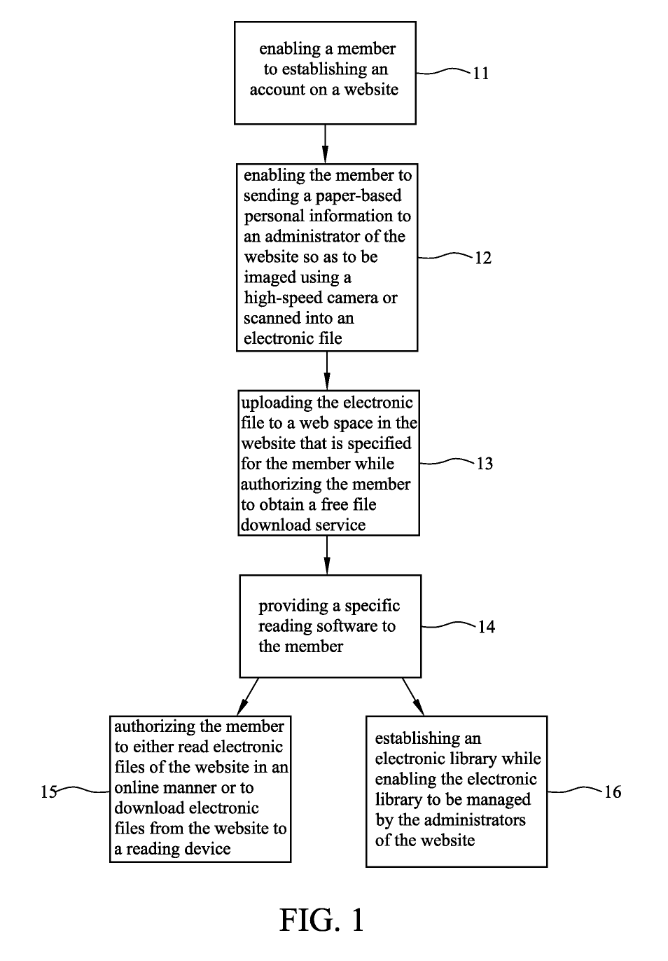

Please refer to FIG. 1, which is a flow chart depicting a method for establishing a personal database according to an embodiment of the present invention. As shown in FIG. 1, a method for establishing a personal database comprises the following steps:
step 11: enabling a member to establishing an account on a website;
step 12: enabling the member to sending a paper-based personal information to an administrator of the website so as to be imaged using a high-speed camera or scanned into an electronic file, while enabling the website to act in response to the request of the member for performing a return process or a donation process upon the paper-based personal information of the member, whereas the unit corresponding to the donation process can be a library or an organization of disadvantaged group;
step 13: uploading the electronic file to a web space in the website that is specified for the member while authorizing the member to obtain a free file download service;
step 14: providing a specific reading software to the member, whereas the specific reading software is designed to recognize files using a format that is not any commonly available format on the market, but is a compact, multi-functional format with high resolution;
step 15: authorizing the member to either read electronic files of the website in an online manner or to download electronic files from the website to a reading device after requiring the member to input accurately an account number and a code corresponding to the account number that are legitimate to the website, whereas the reading device is a device selected from the group consisting of: a personal computer, a notebook computer, a tablet computer, a personal digital assistant and a cellular phone; and
step 16: establishing an electronic library while enabling the electronic library to be managed by the administrators of the website.

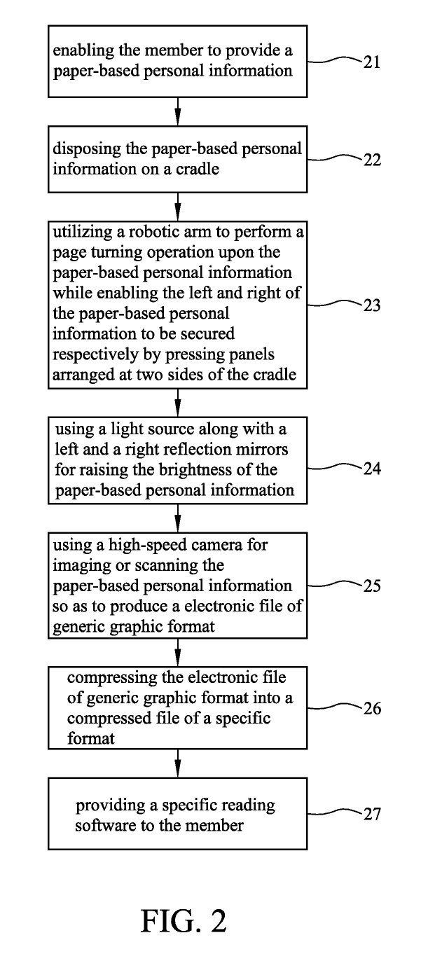

Please refer to FIG. 2, which is a flow chart depicting a method for establishing a personal database according to another embodiment of the present invention. As shown in FIG. 2, a method for establishing a personal database comprises the following steps:
step 21: enabling the member to provide a paper-based personal information;
step 22: disposing the paper-based personal information on a cradle;
step 23: utilizing a robotic arm to perform a page turning operation upon the paper-based personal information while enabling the left and right of the paper-based personal information to be secured respectively by pressing panels arranged at two sides of the cradle, whereas the robotic arm may be designed to perform the page turning operation by utilizing a vacuum means to exert a gentle suction upon pages of the paper-based personal information.;
step 24: using a light source along with a left and a right reflection mirrors for raising the brightness of the paper-based personal information, whereas the right reflection mirror is arranged to reflect light from the left of the paper-based personal information, while the left reflection mirror is arranged to reflect light from the right of the paper-based personal information;
step 25: using a high-speed camera for imaging or scanning the paper-based personal information so as to produce a electronic file of generic graphic format, such as JPEG format, BMP format, GIF format, TIFF format, PNG format or formats conforming to the Office software;
step 26: compressing the electronic file of generic graphic format into a compressed file of a specific format; and
step 27: providing a specific reading software to the member, whereas the specific reading software is designed to recognize files using a format that is not any commonly available format on the market, but is a compact, multi-functional format with high resolution.

During the proceeding of the step 24, the imaging or scanning operation is performed using a high-speed automatic book scanner integrating the patented technologies from Xerox and Palo Altos Lab., which is developed by the Kirtas Technologies, Inc. The automatic book scanner is configured with a cradle that is designed for holding books of various sizes. Operationally, an operator can simply set up parameters corresponding to the size of the book that is loaded in the cradle, the automatic book scanner will be capable of scanning the book at the rate of 1,200 pages per hour. Thus, as a single operator can easily handle the scanning operations of five such high-speed automatic book scanners at the same time, the yield of one operator can reach 5,000 pages per hour. Moreover, as the cradle is formed as a V-shaped object with a 110-degree open angle, books can be loaded in the cradle and opened naturally without destroying the bindings. After a book is being loaded in the cradle, the scanner use a robotic arm to exert a gentle suction upon the book for turning each page of the book loaded in the cradle. After each page-turning is completed, the scanner will activate two pressing panels that arranged at two sides of the cradle to move from the center of the book toward the two sides thereof so as to flatten the open book. Thereafter, a high-resolution camera mounted atop the unit snaps a photo of each page, using a clever system of mirrors to photograph each side and correct for the angle of the open book. It is noted that there can be two reflection mirror that are arranged respectively at the two sides of the V-shaped cradle in a manner that the right reflection mirror is arranged to reflect light from the left of the paper-based personal information for reflecting the same toward the high-resolution camera, while the left reflection mirror is arranged to reflect light from the right of the paper-based personal information for reflecting the same toward the high-resolution camera. As the series of page-turning, flattening, lighting, imaging can be performed orderly and gently without destroying the bindings of the book, the high-speed automatic book scanner can safely scan even fragile antique books.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method for establishing a personal database, comprising the steps of:
enabling a member to establishing an account on a website;
enabling the member to sending a paper-based personal information to an administrator of the website so as to be imaged using a high-speed camera or scanned into an electronic file;
uploading the electronic file to a web space in the website that is specified for the member while authorizing the member to obtain a free file download service; and
providing a specific reading software to the member.

2. The method of claim 1, further comprising the step of:
enabling the website to act in response to the request of the member for performing a return process or a donation process upon the paper-based personal information of the member.

3. The method of claim 1, further comprising the step of:
authorizing the member to either read electronic files of the website in an online manner or to download electronic files from the website to a reading device.

4. The method of claim 3, wherein the reading device is a device selected from the group consisting of: a personal computer, a notebook computer, a tablet computer, a personal digital assistant and a cellular phone.

5. The method of claim 3, wherein the authorization of the member to either read electronic files of the website in an online manner or to download electronic files from the website to a reading device requires the member to input accurately an account number and a code corresponding to the account number that are legitimate to the website.

6. The method of claim 1, further comprising the step of:
establishing an electronic library while enabling the electronic library to be managed by the administrators of the website.
